(19) United States
(12) Patent Application Publication
(10) Pub. No.: US 2006/0193040 A1
(43) Pub. Date: Aug. 31, 2006

(54) Optical unit, method of manufacturing the same, backlight assembly having the same and display device having the same

(76) Inventors: Geun-Hyung Kim, Seongnam-si (KR); Jong-Dae Park, Seoul (KR); Tae-Seok Kim, Suwon-si (KR)

Correspondence Address: CANTOR COLBURN, LLP, 55 GRIFFIN ROAD SOUTH, BLOOMFIELD, CT, 06002, US

(21) Appl. No.: 11/346,086

(22) Filed: Feb. 2, 2006

(30) Foreign Application Priority Data
Feb. 2, 2005 (KR) 2005-9505

(51) Int. Cl. G02B 23/00

(52) U.S. Cl. 359/422

(57) ABSTRACT

An optical unit includes a body, diffusion members and control members. The diffusion members are disposed in the body to diffuse incident light. The control members are disposed in the body to produce diffusion members having substantially uniform sizes. Thus, the optical unit has an enhanced light-diffusing characteristic, thereby improving the uniformity of luminance of light emitted from the optical unit.

This application claims priority to Korean Patent Application No. 2005-9505 filed on Feb. 2, 2005, the contents of which are herein incorporated by reference in its entirety.

### BACKGROUND OF THE INVENTION

1. Field of the Invention

The present invention relates to an optical unit, a method of manufacturing the optical unit, a backlight assembly having the optical unit and a liquid crystal display device comprising the same. More particularly, the present invention relates to an optical unit capable of enhancing light-diffusing characteristics, a method of manufacturing the optical unit, a backlight assembly comprising the optical unit and a liquid crystal display device comprising the same.

2. Description of the Related Art

Generally, liquid crystal has electrical characteristics that permit it's molecules to be rearranged by electric fields. This molecular rearrangement also facilitates changes in the optical characteristics of the liquid crystal, such as optical transmissivity. Such electrical and optical characteristics are used in liquid crystal display (LCD) device to display images. The liquid crystalline molecules emits no light, thus the LCD device including an LCD panel for displaying images employs a backlight assembly for providing the LCD panel with light.

The backlight assembly is classified into a direct illumination type backlight assembly or an edge illumination type backlight assembly. The direct illumination type backlight assembly includes a plurality of light sources disposed under the display panel. The edge illumination type backlight assembly includes a light guiding plate and a light source disposed at a side of the light guiding plate.

The size of a display device that employs the direct illumination type backlight assembly is generally reduced (i.e., is generally small) when the distance between the display panel and the light sources is reduced. However, as the distance decreases, a bright line on the display panel grows clearer due to a difference in luminosity between a first region of the display panel corresponding to a direct upper portion of the light sources and a second region of the display panel corresponding to the remaining portion of the light sources.

Accordingly, the display device includes an optical member between the light sources and the display panel to improve the uniformity of luminance of light emitted from the light sources. However, since a conventional optical member does not diffuse the light sufficiently, the conventional optical member does not effectively overcome the bright line on the display panel when the distance between the display panel and the light sources decreases.

### SUMMARY OF THE INVENTION

The present invention overcomes the aforementioned problems and thus the present invention provides an optical unit capable of enhancing light-diffusing characteristics.

The present invention also comprises a backlight assembly having the above-mentioned optical unit.

The present invention also comprises a display device having the above-mentioned optical unit.

The present invention also comprises a method of manufacturing the above-mentioned optical unit.

In one aspect of the present invention, an optical unit comprises a body, a plurality of diffusion members and a plurality of control members. The diffusion members are disposed in the body to diffuse incident light. The control members are disposed in the body to produce diffusion members having substantially uniform sizes. Each of the diffusion members, for example, has a substantially spherical shape, and diameters of the diffusion members are substantially same. The diffusion members comprise bubbles and/or beads. The body comprises polymer chains, and the control members are interposed among the polymer chains. The control members may comprise particles, each of which has a length of about 1 nanometer (nm) to about 100 nm with respect to at least one direction.

In another aspect of the present invention, a backlight assembly comprises a light source, an optical unit, and a receiving container. The optical unit comprises a body, a plurality of diffusion members disposed in the body to diffuse light provided from the light source and a plurality of control members disposed in the body to provide uniform sizes for the diffusion members. The receiving container receives the light source and the optical unit.

In still another aspect of the present invention, a display device comprises an optical module and a display unit. The optical module comprises a light source and an optical unit. The display unit displays an image using light emitted from the optical module.

In still another aspect of the present invention, a method of manufacturing an optical unit for a display device comprises mixing polymer with particles, each particle of which has a length of about 1 nm to about 100 nm with respect to at least one direction, pressurizing a foaming agent at a pressure greater than an atmospheric pressure to dissolve the foaming agent in a mixture of the polymer and the particles and reducing a applied pressure of the mixture in which the foaming agent is dissolved to generate bubbles in the mixture.

According to the above, the optical unit diffuses light that is incident thereupon through the diffusion member to emit light having an enhanced uniformity of luminance.

### BRIEF DESCRIPTION OF THE DRAWINGS

The above and other advantages of the present invention will become readily apparent by reference to the following detailed description when considered in conjunction with the accompanying drawings wherein:

FIG. 1 is an exemplary cross-sectional view illustrating an optical unit according to the present invention;

FIG. 2 is an enlarged view illustrating portion ‘A’ in FIG. 1;

FIG. 3 is another exemplary cross-sectional view illustrating an optical unit according to the present invention;

FIG. 4 is another exemplary cross-sectional view illustrating an optical unit according to the present invention;

FIG. 5 is an exemplary cross-sectional view illustrating a backlight assembly according to the present invention;

FIG. 6 is an enlarged view illustrating portion ‘B’ in FIG. 5;

FIG. 7 is an exemplary cross-sectional view illustrating a display device according to the present invention;

FIG. 8 is an enlarged view illustrating portion ‘C’ in FIG. 7; and

FIG. 9 is a flow chart illustrating a method of manufacturing an optical unit for a display device according to the present invention.

### DETAILED DESCRIPTION OF THE INVENTION

The present invention now will be described more fully hereinafter with reference to the accompanying drawings, in which embodiments of the invention are shown. This invention may, however, be embodied in many different forms and should not be construed as being limited to the embodiments set forth herein; rather, these embodiments are provided so that this disclosure will be thorough and complete, and will fully convey the scope of the invention to those skilled in the art. Like reference numerals refer to similar or identical elements throughout.

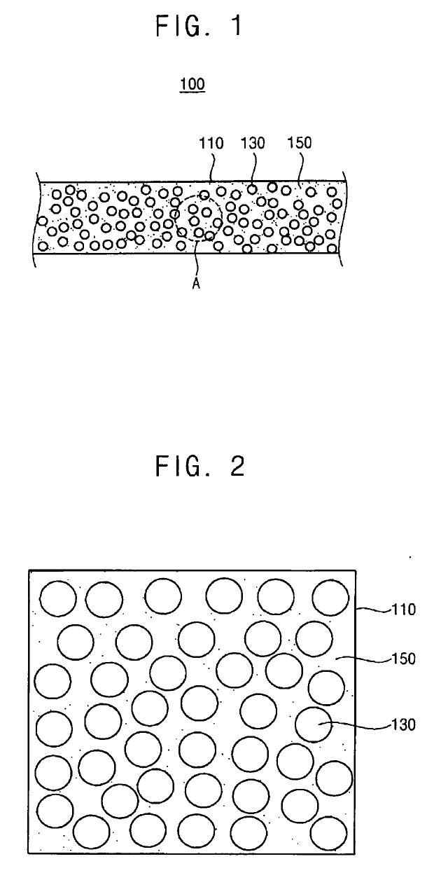

FIG. 1 is an exemplary cross-sectional view illustrating an optical unit according to the present invention.

Referring to FIG. 1, an optical unit 100 according to an exemplary embodiment of the present invention includes a body 110, a diffusion member 130 and a control member 150.

The body 110, for example, is transparent and has a plate-like shape. The body 110 includes polymer resin having good characteristics of optical transmissivity, heat resistance, chemical resistance, mechanical strength, or the like. Examples of polymer resin may include polymethylmethacrylate (PMMA), polyamide, polyimide, polypropylene, polyurethane, or the like. Polymer chains constituting the body 110 are entangled with one another in a chain shape. The adhesive strength of the polymer chains is anisotropic, i.e., it has different values in different directions.

FIG. 2 is an enlarged view illustrating portion ‘A’ in FIG. 1.

Referring to FIG. 2, the diffusion member 130 diffuses light that is incident into the optical unit 100, prior to permitting the light to exit the optical unit 100. Thus, the uniformity of luminance for light emitted from the body 110 is enhanced. The diffusion member 130 is uniformly distributed in the body 110 in order to effectively enhance the uniformity of luminance of the light emitted from the optical unit 100.

The uniformity of luminance of the light emitted from the optical unit 100 increases as the difference between an optical refractive index of the diffusion member 130 and an optical refractive index of the body 110 increases. Thus, when the difference is large, the uniformity of luminance of the light emitted from the optical unit 100 is enhanced.

In one embodiment, the diffusion member 130 comprises a plurality of bubbles generated in the body 110. For example, the bubbles 130 may preferably be uniformly distributed in the body to effectively enhance the uniformity of luminance of the light emitted from the optical unit 100. The sizes of the bubbles 130 are controlled when the bubbles 130 are generated in the optical unit 100.

A mean diameter of the bubbles 130 may be varied according to various factors, for example, such as a temperature, a pressure, a time, or the like, at which the polymer resin is heated in order to grow nuclei which lead to the bubbles 130. In one embodiment, it is desirable for the total volume percentage of the bubbles 130 with respect to the optical unit 100 to be constant. In another embodiment, it is desirable for the bubbles 130, to have a small radius and therefore to have a large total surface area. As a result of the small radius size and the large surface area, the light that is incident into the optical unit 100 is easily diffused.

The bubbles 130 have substantially identical diameters to one another, and all the diameters of the bubbles 130 may be increased or decreased simultaneously. The mean diameter of the bubbles 130, for example, is in a range of about 1 micrometer (μm) to about 20 μm.

The volume percentage of the bubbles 130 with respect to the optical unit 100, for example, is in a range of about 1% to about 10%, based on the volume of the body 110. As a result of having a constant volume of bubbles of a fairly constant size and surface area, the optical unit 100 can diffuse light in a consistent and reproducible manner. In addition, there is no substantial loss in the mechanical strength of the body 110.

In order to produce bubbles having the aforementioned characteristics, a foaming agent such as carbon dioxide (CO₂), nitrogen (N₂), or the like, is dissolved in the body 110 under an applied pressure that is tens of times greater than atmospheric pressure. The bubbles 130 are generated in the body 110 by reducing the applied pressure.

The size of each bubble 130 is directly proportional to the growth time and becomes larger as each bubble 130 has a long growth time. Thus, the size of each bubble 130 may be controlled by controlling the growth time thereof.

The volume percentage of the bubbles 130 with respect to the optical unit 100 are determined by sizes of the bubbles 130 and a number of the bubbles 130 per unit volume of the body 110. The number of the bubbles 130 per unit volume of the body 110 increases with the increase in the rate of change of the surrounding pressure of the body 110 in which the foaming agent is dissolved. Thus, when the sizes of the bubbles 130 are determined, the number of the bubbles 130 per unit volume of the body 110 is controlled by controlling the rate of change of the surrounding pressure of the body 110. As a result, the volume percentage of the bubbles 130 with respect to the optical unit 100 may be controlled.

The control member 150 is disposed in the polymer to change the diffusion characteristics of the body 110. The control member 150, for example, includes nano-sized particles in order to be related to the polymer chains at a molecule scale. The particles of the control member 150 generally have a length of about 1 nm to about 100 nm in one dimension.

The nano-sized particles are dispersed in the polymer to prevent thermal deformation of the body 110, to restrain the permeability of moisture and gas, and to enhance the strength and modulus of the body 110.

For example, the nano-sized particles provide reinforcement to the entangled polymer chains thereby improving adhesion between the nano-sized particles and the polymer and producing isotropic mechanical properties in the optical unit 100. Thus, when the bubbles 130 generated in the body 110 grow, the surfaces of the bubbles 130 encounter uniform resistance to growth. Hence, the bubbles 130 have uniform sizes in the body 110. The nuclei of the bubbles 130 also have uniform densities in the body 110, so that the bubbles 130 are uniformly distributed in the body 110.

The light that is incident into the optical unit 100 is refracted and reflected on the surfaces of the bubbles 130. When the bubbles 130 are more uniformly generated in the optical unit 100, the optical unit 100 may diffuse light more uniformly to emit light having uniform luminance. The particles having nano-sizes do not facilitate any reduction in the luminance of light that is transmitted in the optical unit 100.

The control member 150, for example, may comprise nano-sized particles having a metal and/or an inorganic material such as phyllosilicates (or layered silicate), polyhedral oligomeric silsesquioxanes, carbon nanotubes, carbon nanofibers, nanosilicas, titanium oxide (TiO₂), aluminum oxide (AL₂O₃), or the like.

In one embodiment, the control member 150 includes montmorillonite (MMT) that is a species of clay having a molecule structure of layered silicate. The MMT includes a combination of a silica tetrahedral sheet and an alumina octahedral sheet facing the silica tetrahedral sheet. Although the total size of clay layers generally corresponds to about 1000 nm, intervals between the clay layers of as little as about 1 nm will suffice.

Accordingly, an organic material such as a polymer will not easily diffuse between the clay layers. In order to easily insert the organic material (i.e., the polymer) into the hydrophillic MMT, hydrochloride-derivatives such as methylamine hydrochloride and amine-derivatives such as propyl amine may be used for emulsifying agents to change hydrophillic MMT into oleophillic MMT.

The volume percentage of the control members 130 with respect to the optical unit 100, for example, are in the range of about 0.1% to about 0.5%.

The optical unit 100 may include intercalation type nano-composites wherein polymer is intercalated between silicate layers of MMT by either a solution method, a polymerization method and/or a compounding method. Alternatively, the optical unit 100 may comprise exfoliation type nano-composites wherein silicate layers of MMT are exfoliated.

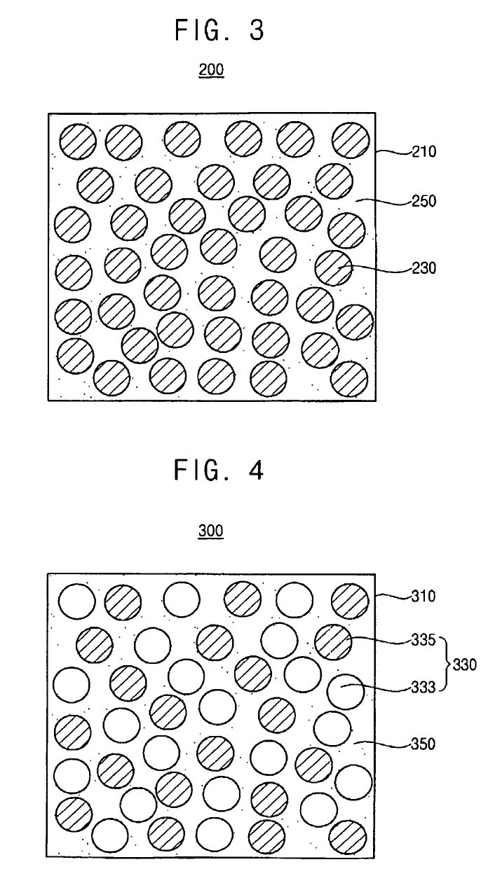

FIG. 3 is an exemplary cross-sectional view illustrating an optical unit according to the present invention. The optical unit 200 is substantially identical to the optical unit 100 in FIGS. 1 and 2 except for the presence of a diffusion member. Thus, any further description for substantially same elements will be omitted.

Referring to FIG. 3, the optical unit 200 according to another exemplary embodiment of the present invention includes a body 210, a diffusion member 230 and a control member 250.

The diffusion member 230 diffuses light that is incident onto the optical unit 200 prior to the light exiting the optical unit 200. In one embodiment, the diffusion member 230 includes a plurality of beads. The beads 230, for example, have an optical refractive index that is less than the refractive index of the body 210 such that the difference facilitates diffusion of light by the optical unit 200. The beads 230 may be uniformly distributed in the body such that the optical unit 200 uniformly diffuses the incident light.

Each of the beads 230, for example, has a spherical or an ellipsoidal shape. In one embodiment, it is desirable for each of the beads 230 to have a small radius. Thus, the total surface area of the beads 230 present in the body 210 is large, so that the optical unit 200 may effectively diffuse the incident light.

In one embodiment, the beads 230 have substantially identical diameters to one another. The mean diameter of the beads 230, for example, is in the range of about 1 μm to about 20 μm.

The volume percentage of the beads 230 with respect to the optical unit 200, for example, is in the range of about 1% to about 10%. Thus, the optical unit 200 may have a desired diffusivity.

FIG. 4 is another exemplary cross-sectional view illustrating an optical unit according to the present invention. The optical unit 300 is substantially identical to the optical unit 100 in FIGS. 1 and 2 except for the presence of a diffusion member. Thus, any further description for the substantially same elements will be omitted.

Referring to FIG. 4, the optical unit 300 according to still another exemplary embodiment of the present invention includes a body 310, a diffusion member 330 and a control member 350.

The diffusion member 330 diffuses the light that is incident onto the optical unit 300 to enhance the uniformity of luminance. In one embodiment, the diffusion member 330 includes bubbles 333 and beads 335. The optical refractive index of each bubble 333 and the optical refractive index of each bead 335 are less than the optical refractive index of the body 310. The bubbles 333 and the beads 335 may be uniformly distributed in the body 310 such that the optical unit 300 uniformly diffuses the incident light.

The control member 350 having nano-sized dimensions is disposed in the polymer contained in the body 310. The nano-sized particles provide reinforcement to the entangled polymer chains thereby improving adhesion between the nano-sized particles and the polymer and producing isotropic mechanical properties in the body 310. As a result, the bubbles 333 and the beads 335 are uniformly generated and distributed in the body 310.

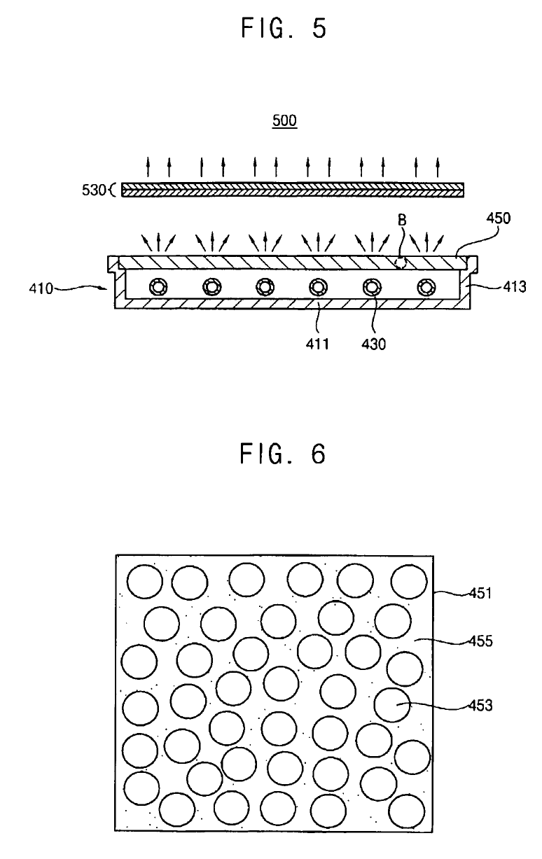

FIG. 5 is an exemplary cross-sectional view illustrating a backlight assembly according to the present invention. FIG. 6 is an enlarged view illustrating portion ‘B’ in FIG. 5.

Referring to FIGS. 5 and 6, the backlight assembly 500 according to an exemplary embodiment of the present invention includes a receiving container 410, a light source 430 and an optical unit 450.

The receiving container 410 includes a bottom plate 411 and a sidewall 413 that protrudes from an outer portion of the bottom plate 411 to define a receiving space. The light source 430, for example, includes a fluorescent lamp. In one embodiment, the light source 430 includes a plurality of lamps disposed on the bottom plate 411.

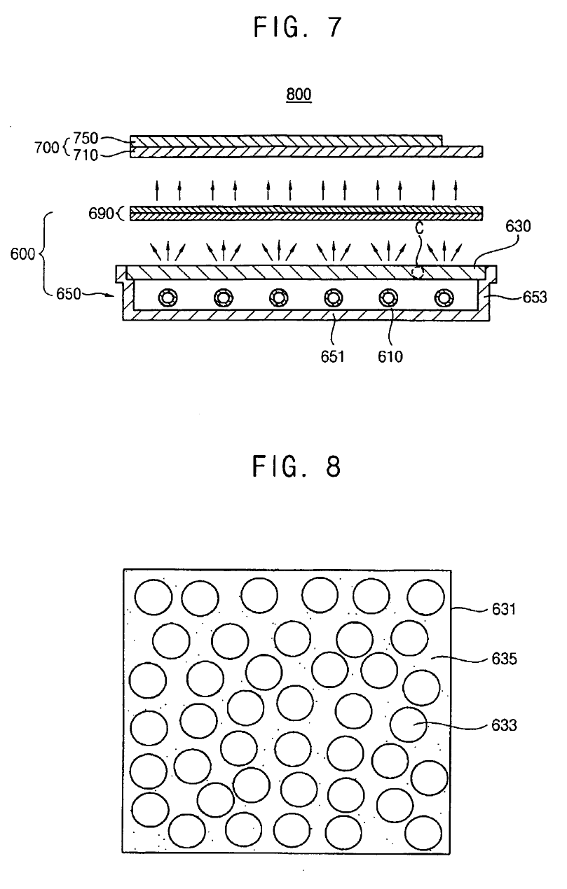

The backlight assembly 500 may include at least one of the optical unit 100 shown in FIGS. 1 and 2, the optical unit 200 shown in FIG. 3, and the optical unit 300 shown in FIG. 4. Referring to FIG. 7, the optical unit 450 of this embodiment is substantially identical to the optical unit 100 shown in FIGS. 1 and 2. The optical unit 450 includes a body 451 diffusion members 453 and control members 455, which are substantially identical to those of the optical unit 100.

The optical unit 450 receives light emitted from the lamp 430 to enhance the luminance of the light. In one embodiment, the optical unit 450, for example, has a plate-like shape, and the optical unit 450 is disposed over the lamps 430. In another embodiment, the lamps 430 may be disposed facing a side of the optical unit 450.

When the optical unit 450 is disposed over the lamps 430, the difference in luminance between a first region corresponding to a direct upper portion of the lamps 430 and a second region corresponding to a remaining portion of the lamps 430 is large. Thus, in order to compensate for the luminance difference, the optical unit 450 is maintained at a predetermined distance from the lamps 430.

The backlight assembly 500 optionally includes at least one optical sheet 530. The optical sheet 530 is disposed over the optical unit 450 to enhance optical characteristics of light emitted from the optical unit 450. The optical sheet 530, for example, enhances the front-view luminance of light.

FIG. 7 is an exemplary cross-sectional view illustrating a display device according to the present invention. FIG. 8 is an enlarged view illustrating portion ‘C’ in FIG. 7.

Referring to FIGS. 7 and 8, a display device 800 according to an exemplary embodiment of the present invention includes an optical module 600 and a display unit 700.

The optical module 600 includes a light source 610 and an optical unit 630. The light source 610, for example, includes a fluorescent lamp. In one embodiment, the optical unit 630 is substantially identical to the optical unit 100 shown in FIGS. 1 and 2. The optical unit 630 receives light emitted from the lamp 610 to enhance the uniformity of luminance of the light.

The optical module 600 may further include a receiving container 650 and at least one optical sheet 690. The receiving container 650 includes a bottom plate 651 and a sidewall 653 that protrudes from an outer portion of the bottom plate 651 to define a receiving space. The optical unit 630 is disposed over the receiving container 650 and is separated by a predetermined distance from the lamp 610. The optical sheet 690 is disposed over the optical unit 630 to enhance optical characteristics of the light emitted from the optical unit 630. The optical sheet 690, for example, enhances front-view luminance of the light.

The display unit 700 is disposed over the optical module 600 to display images using light emitted from the optical module 600. The display unit 700 includes a first substrate 710, a second substrate 750 and a liquid crystal layer (not shown disposed between the substrates 710 and 750).

The first substrate 710 includes a transparent glass substrate on which a thin film transistor (TFT) having a matrix shape is formed. A pixel electrode including a transparent conductive material is formed on the first substrate 710.

The second substrate 750 faces the first substrate 710. An RGB (Red-Green-Blue) pixel is formed on the second substrate 750 through a thin film process. A common electrode is formed on the second substrate 750. The common electrode comprises a transparent conductive material that corresponds to the pixel electrode formed on the first substrate 710.

When electric fields are generated between the pixel electrode and the common electrode, liquid crystalline molecules of the liquid crystal layer between the first and second substrates 710 and 750 are rearranged. When an arrangement of the liquid crystalline molecules is changed, optical transmissivity thereof is also changed to display an image having a desired gradation.

The optical unit 630 includes bubbles that act as diffusion members 633 for diffusing incident light, and a control member 635 that controls the size of each bubble to have size similar to that of other bubbles. Thus the control member facilitates the presence of bubbles having a uniform size. Thus, even though the distance between the lamp 610 and the optical unit 630 is reduced, bright lines on the display unit 700 may not increase greatly.

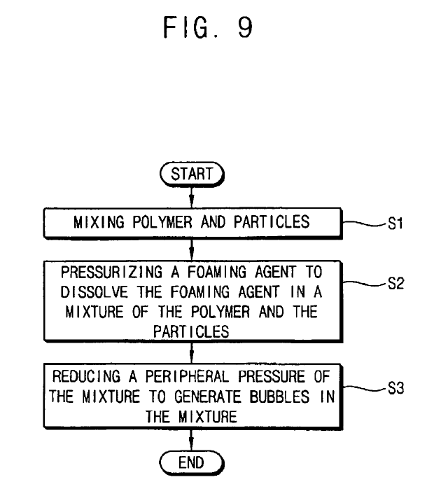

FIG. 9 is a flow chart illustrating a method of manufacturing an optical unit for a display device according to an exemplary embodiment of the present invention.

Referring to FIG. 9, in step S1, fine particles are mixed in a polymer. The polymer may be in the molten state. Each of the particles mixed in the polymer, for example, is in the nanometer size range. Each of the nano particles has a length of about 1 nm to about 100 nm in at least one dimension. The nano-sized particles are scattered among the polymer chains to change a mechanical strength, thermal characteristics, optical characteristics, or the like, of the polymer. For example, the nano particles reinforce the polymer chains that are entangled with one another, and bonding strength of the optical unit 100 may be isotropic by the nano particles.

Then, in step S2, a pressure that is tens of times that of the atmospheric pressure is applied to a foaming agent such as inert gas of carbon dioxide (CO₂), nitrogen (N₂), a solvent, or the like, so that the foaming agent is dissolved in a mixture of the polymer and the nano particles. The mixture of the polymer and the nano particles, for example, is in a solid state. Alternatively, the mixture of the polymer and the nano particles may be in a liquid state. The foaming agent may be dissolved in the mixture of the polymer and the nano particles to be saturated.

At last, in step S3, the applied pressure of the mixture in which the foaming agent is dissolved is reduced, and the mixture is heated above a glass transition temperature of the polymer. During this heating, the characteristics of the polymer change greatly and the polymer occupies a state between that of the liquid state and the solid state. In these conditions, nuclei of bubbles generated in the mixture grow to be bubbles. This concludes the formation of an optical unit for the display device.

When the foaming agent is dissolved in the mixture of the polymer and the nano particles, wherein the mixture is in the liquid state, the mixture can be transmitted through a nozzle. After being transmitted through the nozzle, the mixture having a high pressure and a high temperature is changed into a mixture having a low pressure and a low temperature. Thus, the mixture becomes thermodynamically unstable and the nuclei of the bubbles generated in the mixture undergo binodal decomposition to form bubbles.

According to the above, nano-sized particles uniformize the sizes of the bubbles. In other words, the nano particles dispersed among the polymer chains uniformize the chain structure in view of mechanical strength. Thus, the bubbles generated in the polymer have uniform sizes, and the bubbles are uniformly distributed.

According to the present invention, the optical unit includes bubbles that are used as a diffusion member for diffusing light. Each of the bubbles has an optical refractive index lower than the optical refractive index of the polymer. Thus, when the optical unit uses bubbles as diffusion members, it has an optical diffusivity that is greater than an optical unit that uses beads as the diffusion members.

In addition, the optical unit advantageously includes a control member that facilitates the production of bubbles having uniform sizes and in addition permits the bubbles to be uniformly distributed. Thus, even though the distance between the lamp and the optical unit is reduced, bright lines on the optical unit may not increase greatly.

In one embodiment, as the distance between the lamp and the optical unit is reduced greatly, the bright lines on the optical unit will decrease and the display quality of the display device is enhanced.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. An optical unit comprising:
a body;
a plurality of diffusion members disposed in the body to diffuse incident light; and
a plurality of control members disposed in the body to produce substantially uniform sizes for the diffusion members.

2. The optical unit of claim 1, wherein each of the diffusion members has a substantially spherical shape, and diameters of the diffusion members are substantially the same.

3. The optical unit of claim 2, wherein a mean diameter of the diffusion members is in a range of about 1 micrometer to about 20 micrometers.

4. The optical unit of claim 2, wherein a volume percentage of the diffusion members with respect to the optical unit are in a range of about 1% to about 10%.

5. The optical unit of claim 1, wherein the diffusion members comprise bubbles.

6. The optical unit of claim 5, wherein a refractive index of the bubbles is less than a refractive index of the body.

7. The optical unit of claim 1, wherein the diffusion members comprise beads.

8. The optical unit of claim 7, wherein a refractive index of the beads is less than a refractive index of the body.

9. The optical unit of claim 1, wherein the diffusion members comprise bubbles and beads.

10. The optical unit of claim 1, wherein the body comprises a polymer, and the control members are disposed in the polymer.

11. The optical unit of claim 10, wherein the control members comprise particles each of which has a length of about 1 nanometer to about 100 nanometers in at least one dimension.

12. The optical unit of claim 10, wherein each of the control members has a layered molecular structure, and wherein the polymer is intercalated between layers of each control member.

13. The optical unit of claim 10, wherein a volume percentage of the control members with respect to the optical unit is in a range of about 0.1% to about 0.5%.

14. The optical unit of claim 1, wherein the control members comprise phyllosilicates (or layered silicate), polyhedral oligomeric silsesquioxanes, carbon nanotubes, carbon nanofibers, nanosilicas, titanium oxide (TiO₂), and/or aluminum oxide (AL₂O₃).

15. The optical unit of claim 1, wherein the control members comprise MMT (montmorillonite) including a combination of a silica tetrahedral sheet and an alumina octahedral sheet facing the silica tetrahedral sheet.

16. A backlight assembly comprising:
a light source;
an optical unit comprising:
a body;
a plurality of diffusion members disposed in the body to diffuse light provided from the light source; and
a plurality of control members disposed in the body to produce substantially uniform sizes for the diffusion members; and
a receiving container receiving the light source and the optical unit.

17. The backlight assembly of claim 16, wherein each of the diffusion members has a substantially spherical shape, and diameters of the diffusion members are substantially the same.

18. The backlight assembly of claim 16, wherein the diffusion members comprise bubbles.

19. The backlight assembly of claim 18, wherein the diffusion members further comprise beads.

20. The backlight assembly of claim 16, wherein the body comprises a polymer and the control members are disposed in the polymer.

21. The backlight assembly of claim 20, wherein the control members comprise particles each of which has a length of about 1 nanometer to about 100 nanometers in at least one dimension.

22. The backlight assembly of claim 20, wherein each of the control members has a layered molecular structure, and wherein the polymer is intercalated between layers of each control member.

23. A display device comprising:
an optical module comprising:
a light source; and
an optical unit comprising a body, a plurality of diffusion members disposed in the body to diffuse light provided from the light source, and a plurality of control members disposed in the body to produce substantially uniform sizes for the diffusion members; and
a display unit disposed over the optical module to display images using light emitted from the optical module.

24. The display device of claim 23, wherein each of the diffusion members has a substantially spherical shape, and diameters of the diffusion members are substantially the same.

25. The display device of claim 23, wherein the diffusion members comprise bubbles.

26. The display device of claim 23, wherein the body comprises a polymer, and wherein the control members are disposed in the polymer.

27. The display device of claim 26, wherein the control members comprise particles each of which has a length of about 1 nanometer to about 100 nanometers in at least one dimension.

28. A method of manufacturing an optical unit for a display device, comprising:
mixing polymer and particles each of which has a length of about 1 nanometer to about 100 nanometers in at least one dimension;
pressurizing a foaming agent at a pressure greater than atmospheric pressure to dissolve the foaming agent in a mixture of the polymer and the particles; and
reducing a pressure of the mixture in which the foaming agent is dissolved to generate bubbles in the mixture.

29. The method of claim 28, wherein each of the bubbles has a substantially spherical shape, and the bubbles are generated to have substantially same diameters.

30. The method of claim 28, wherein the mixture comprises a polymer, and the particles are disposed in the polymer.

31. The method of claim 28, wherein the polymer is in molten state.

32. The method of claim 31, wherein the mixture is in one of solid state and liquid state.
